(19) United States
(12) Patent Application Publication
(10) Pub. No.: US 2005/0054288 A1
(43) Pub. Date: Mar. 10, 2005

(54) Method for dynamic load management of random access shared communications channels

(76) Inventor: Anil K Agarwal, Gaithersburg, MD (US)

Correspondence Address: SUGHRUE MION, PLLC, 2100 PENNSYLVANIA AVENUE, N.W., SUITE 800, WASHINGTON, DC, 20037, US

(21) Appl. No.: 10/474,815

(22) PCT Filed: Apr. 11, 2002
(86) PCT No.: PCT/US02/08255

Related U.S. Application Data
(60) Provisional application No. 60/283,914, filed on Apr. 13, 2001.

(51) Int. Cl. H04B 7/185

(52) U.S. Cl. 455/13.1; 455/509; 370/316

(57) ABSTRACT

A novel method for dynamic load management of random access channels (also known as Aloha channels) in shared communications systems, such as satellite (4), cable, and wireless communications networks is provided. The method provides algorithms and procedures to accurately estimate traffic load offered by multiple distributed terminals (1a, 1b, . . . 1n) into the channel (2). And also provides for regulating traffic so that the channel (2) is not overloaded. The traffic load management algorithms can be done at a central site, such as a Network Control Center (3) or a cable head-end. Alternatively, traffic load management can be done in a distributed manner by all terminals. Traffic regulation is done in a fair manner across all terminals. The algorithms are designed for efficient implementation in software and/or hardware.

This application claims the benefit of U.S. Provisional Application No. 60/283,914, filed Apr. 13, 2001, under 35 U.S.C. § 119(e).

### BACKGROUND OF THE INVENTION

1. Field of the Invention

The present invention relates to a system and method for managing a dynamic load of random access channels. More specifically, the present invention uses various novel methods to estimate traffic in order to prevent overloading of any random access channel.

2. Background of the Invention

In the related art, shared-resource communications networks such as satellite, cable, and terrestrial wireless systems use a variety of methods for sharing network bandwidth among multiple distributed terminals. Many related art systems include a related art “random-access” (i.e., Aloha) method as one of the channel access methods. Typically, certain channels among various carriers are designated as random-access channels, and are available for use by any terminal at any time.

However, the aforementioned related art computer program and system have various problems and disadvantages. For example, but not by way of limitation, multiple terminals may simultaneously transmit into the random-access channel to cause the bursts to “collide,” and the data is lost. In response, the data is typically retransmitted by the terminals in a manner that minimizes the probability of a re-collision.

The aforementioned related art random access channels are typically used for sending signaling and control messages to a central Network Control Center (NCC), as well as for user data traffic, especially if the user traffic is bursty and intermittent.

If the input traffic load exceeds a certain threshold, then the useful throughput of the random access channel declines, due to the aforementioned related art problem of colliding bursts that are retransmitted, thus further increasing the channel load. If the related art random-access slots are time-aligned (i.e., slotted aloha), then the maximum throughput of such channels is 36% of channel capacity. However, if the random access time slots are not time-aligned, then the maximum throughput is only 18%.

Also, related art systems with many terminals require a mechanism to estimate the load into the random-access channel, so that traffic can be reduced when the load exceeds a prescribed threshold. Related art approaches to this issue have used a centralized method, where the central NCC gathers channel load information and distributes estimated loading factors to terminals. For example, but not by way of limitation, related art approaches have used collision detection hardware techniques to estimate channel loading, or information from the messages themselves that is indicative of whether the message is an original message or a retransmission.

However, the aforementioned related art approaches have various problems and disadvantages. For example, but not by way of limitation, the related art approaches work only for networks where the contention channels can be monitored by the NCC. However, in many networks such an arrangement is not possible. Networks that contain a large number of terminals require considerable processing power at the NCC to monitor the large number of contention channels.

Further, a related art network may contain contention channels for direct terminal-to-terminal traffic, and as a result, the NCC may not have access to those channels. Also, the related art centralized approach requires feedback to the terminal indicating whether a message was receive correctly. In centralized systems, the NCC provides feedback when a message is correctly received, whereas collision of a message is indicated by the lack of feedback within a certain timeout period.

### SUMMARY OF THE INVENTION

It is an object of the present invention to overcome at least the aforementioned problems and disadvantages of the related art system.

It is another object of the present invention to provide a system and method for use in networks with centralized as well as distributed channel monitoring and control.

It is also an object of the present invention to provide a distributed approach in a satellite network with on-board processing as an example of a specific implementation and description.

To achieve at least the foregoing objects, a method of sharing bandwidth among a plurality of terminals communicating with a satellite is provided, comprising (a) designating a random access channel that is available for use by any of the plurality of terminals; (b) estimating a load at the random access channel, wherein each of the terminals receives a control signal indicative of a traffic level of the random access channel, from the satellite and monitors the control signal to determine whether a data message transmitted from the terminals has been received in the satellite; (c) retransmitting the data message from one of the terminals to the satellite if the terminal has not received the control signal within a first predetermined time period; (d) discarding the message in the terminal if the satellite has received the message.

Additionally, a system for sharing bandwidth during communication is provided, comprising a plurality of terminals configured to wirelessly communicate with one another, and a random access channel configured to communicate data messages between any of the plurality of terminals in accordance with an estimated load of the random access channel, wherein each of the terminals receives a control signal indicative of a traffic level of the random access channel from a satellite, and monitors the control signal to determine whether a data message transmitted from the terminals has been received in the satellite.

### BRIEF DESCRIPTION OF THE DRAWINGS

The accompanying drawings, which are included to provide a further understanding of illustrative, nonlimiting embodiments of the present invention and are incorporated in and constitute a part of this specification, illustrate embodiments of the invention and together with the description serve to explain the principles of the drawings.

FIG. 1 illustrates an exemplary embodiment of the system according to the present invention; and

FIG. 2 illustrates an exemplary embodiment of random access time slots according to the present invention.

### DETAILED DESCRIPTION OF ILLUSTRATIVE EMBODIMENTS OF THE INVENTION

Reference will now be made in detail to an illustrative, non-limiting embodiment of the present invention, examples of which are illustrated in the accompanying drawings. In the present invention, the terms are meant to have the definition provided in the specification, and are otherwise not limited by the specification.

The present invention includes networks having terminals, where each terminal receives its own random-access burst, as well as bursts of other terminals that share the random-access channel. On-board processing and routing satellites employ multiple geographic beams, and are configured to receive multiple messages in a contention channel burst. Each message is independently routed by the satellite, depending on destination address or virtual circuit identifier of the message. The present invention includes a method that uses the above-described. technique to send a random access channel control signal in each burst (e.g., a control message), that is monitored by the transmitting terminal or by all terminals sharing the channel.

The receipt or non-receipt of the control message provides immediate indication to the transmitting terminal as to whether the burst was received without collision at the satellite. This indication is used to decide whether to retransmit the message. An exponential backoff technique is used to minimize the probability of re-collision.

Two exemplary techniques of the present invention are described below for channel loading estimation. In a first exemplary technique of the present invention, all control messages are received and monitored by all terminals. Each control message contains information that allows each terminal to independently and accurately compute the channel loading within a short period of time. Also, each terminal independently blocks a certain fraction of its traffic from entering the contention channel (i.e., random access channel) to maintain the net channel loading below a prescribed threshold value. In a second exemplary technique of the present invention, each terminal receives and monitors its own control messages only. The second exemplary technique considerably reduces the processing load on each terminal, with only a small reduction in accuracy and overall fairness.

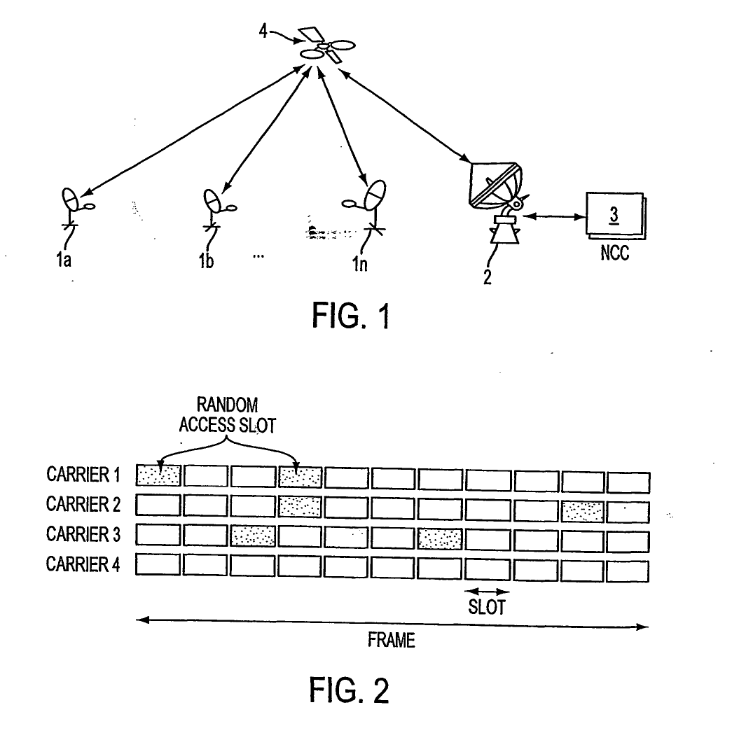

The exemplary method of the present invention is described with respect to a satellite network as shown in FIG. 1. However, the present invention is not limited thereto. FIG. 1 illustrates a plurality of user terminals 1a, 1b . . . 1n, as well as a transmitter 2 and central network control center (NCC) 3, all of which communicate with one another via a satellite 4. Bandwidth from the terminals 1a . . . 1n to the satellite 4 (uplink) is shared using FDMA (Frequency Division Multiple Access) and TDMA (Tine Division Multiple Access) techniques. A certain amount of space spectrum is divided into N TDMA carriers, each carrier is divided into frames in time, and each frame contains a prescribed number of time slots (i.e., channels). A group of terminals share a set of carriers and the channels within those carriers for sending data to the satellite. The satellite routes data contained in channels to the appropriate destination terminals on the downlink carriers. The method described here applies to at least one set of uplink carriers shared by at least one set of terminals, but is not limited thereto.

A set of channels is designated as random-access time slots (or channels). FIG. 2 illustrates an example of random access channels in a FDMA/TDMA system according to the present invention. A channel may contain multiple messages (or packet segments or cells), and each message in the channel can be independently routed by the satellite depending on its destination address or its virtual circuit identifier.

When a terminal (e.g., 1a) determines that it needs to use a random-access channel for sending one or more data messages, the terminal discards the data messages with a probability b, where b is the blocking probability for the channel (i.e., blocking factor). In the related art, excessive traffic results in collisions, which in turn results in decreased throughput. As a result, there is a need to constrain traffic to a predetermined level (e.g., 36%) in order to limit collisions. For example, but not by way of limitation, when traffic exceeds 36%, collisions occur to substantially lower throughput in the related art.

In the present invention, the blocking factor b blocks a certain portion of the traffic when the traffic is considered to be high (e.g., greater than or equal to 36%). As a result, traffic at the random channel is managed to reduce collisions through use of the blocking factor in hardware and/or software.

When the channel load is high, b is used to block out a certain percentage of the traffic from entering the channel. In the present invention, the term “blocking” includes, but is not limited to, throwing away the packet to avoid having that packet collide in the random channel. An attempt may be made at a later time to retransmit the packet.

If the data message is not discarded, then the data message is sent in the next available random access channel, along with a control message that contains the value b (i.e., blocking probability) and a retransmission number nr that is initially set to 0. As noted above, the blocking probability is used to prevent a certain part of the traffic from entering the random channel, thus preventing collisions. Further, the retransmission number is incremented only when retransmission is required, and is otherwise set to zero if the packet is transmitted without requiring retransmission.

The transmitting terminal monitors the downlink channels to determine whether the control message has been received correctly by the satellite and routed towards the destination terminal. If the control message has been received, then the data message is discarded. Further, if the control message has not been received within a timeout period, then the terminal selects a random access channel from the next N random access slots, where N=RI*2^{nr-1}. The foregoing relationship represents the use of exponential backoff, and generally represents that N doubles each subsequent time that retransmission is required. For example, but not by way of limitation, if nr=0, then N=RI, and if nr=1, then N=2RI. On subsequent retransmissions, N=4RI, then 8RI and then 16RI, and so on, as long as further retransmission is required.

As noted above, nr is the retransmission number of the message, 0<=nr<MaxR, and further, RI is the initial randomization interval in slots, RI>0. The message is retransmitted in the selected channel with the control message. As noted above, the control message contains the value b and retransmission number nr. However, if the control message is not received after MaxR transmissions or within a certain “giveup” timeout period, then the message is discarded.

The exemplary description of the present invention uses an exponential backoff strategy to improve the probability of success on each retransmission. Other schemes, such a linear or constant backoff, can also be used. However, the present invention is not limited thereto.

Alternatively, in frame-based TDMA systems, a terminal may select a random access channel from among the next F frames, where F=ceiling((RI*2^{nr-1})/S), and S represents the number of useable random access channels per frame.

In the first exemplary method of the present invention, each terminal monitors the control messages sent by every terminal. The value of blocking factor b is initialized to 0, and a value of nravg, which is an average of received nr values and is described in greater detail below, is initialized to 0. Every T3 seconds, the terminal performs at least the following two computations.

In a first computation, a terminal computes nravg as the average of the nr values in all the control messages received over the past T3/2 seconds. If no control messages are received in that period, then nravg is set to the previous value of nravg multiplied by 0.95. In a second computation, a terminal computes bavg as the average of the b values in all the control messages received over the past T3/2 seconds. If no control messages are received in that period, then bavg is set to b.

The foregoing first and second computations may be performed in any order, and are performed on a subset of the control messages received over the past T3/2 seconds. After computing navg and bavg as described above, the terminal computes b as described below.

A value for channel load g and a value for channel input load si are obtained, and then a value of a subtractive factor a is calculated based on b and bavg. The value of a is modified based on the value of g and si, and a is then subtracted from 1 to obtain the value of b. Further details of the process are illustrated in the exemplary pseudocode provided below, where MaxInputLoad represents the maximum allowed channel input load parameter.

| | |
|---|---|
| g = ln(nravg + 1) | - channel load, ln( ) is log to the base e |
| si = g / (nravg + 1) | - channel input load, when g <= 1 |
| a = 1 − (b + bavg) / 2 | - subtraction factor |

```
if g > 1 then
    a = a / 2
else if si > MaxInputLoad then
    a = a * MaxInputLoad / si
else
    a = (a + min(a * MaxIuputLoad / si, 1)) / 2
endif
```

| | |
|---|---|
| a = max(a, .01) | - keep a > 0 |
| b = 1 − a | |

In the foregoing calculations, bavg is used so that all terminals converge to the same value of b. Additionally, overall system behavior is a function of the average value of b across all terminals. Without use of the foregoing bavg feature, different terminals would compute different values of b while the overall average is the correct value for the system. In such a case, loss of fairness across terminals would result.

In the exemplary embodiment of the present invention, the following typical values for the various parameters are shown below:
MaxR=6;
MaxInputLoad=0.3;
RI=8; and
T3=5 seconds.

Parameter values are dynamically configurable, so that appropriate values can be selected depending on network architecture and size.

In the second exemplary embodiment of the present invention, each terminal monitors its own control messages only. The value of b is initialized to 0. When a control message is received by the terminal, the following steps are performed:

if nr >= NRTH then

b = 1 − max((1 − b) * ADEC, MINA)

else if nr < NRTH − 1 then

b = 1 − min((1 − b) * AINC, 1)

endif

In the foregoing process, NRTH represents a threshold value such that if the number of retransmissions nr of a successfully delivered message is greater than or equal to NRTH, the channel load is too high. ADEC represents a factor by which (1−b) is decreased when the channel load appears high, and AINC represents a factor by which (1−b) is increased when the channel load appears low. MINA represents the minimum value allowed for (1−b). If neither of the above-described conditions are satisfied with respect to NRTH, then the value of b remains unchanged.

Whenever a random access channel transmission is unsuccessful (i.e., the giveup timer expires or the cells are transmitted MaxR times), the following computation is performed by one of the terminals:
b=1−max((1−b)*ADEC, MINA)

Exemplary values for the various parameters for the second exemplary embodiment of the present invention are described below. However, the present invention is not limited thereto:
MaxR=6;
ADEC=0.85;
AINC=1.1;
MINA=0.5;
NRTH=2; and
RI=8.

Parameter values are dynamically configurable. Thus, appropriate values can be selected depending on network architecture and size.

Unlike the first exemplary embodiment of the present invention, in the second exemplary embodiment, a terminal does not have access to all activity on the channel. As a result, the channel cannot compute b on an ongoing basis. Hence, the second exemplary embodiment of the present invention uses an iterative scheme to incrementally increase or decrease b, depending on the result of a message sent on the channel by that terminal.

In both of the foregoing exemplary descriptions the present invention, the values of the blocking factor b in one or more terminals are typically collected by the NCC periodically, to perform long-term monitoring of the channels and to determine whether additional channel capacity is needed.

As noted above, the present invention is not limited to the foregoing exemplary descriptions, and additional descriptions are described in greater detail below. For example, but not by way of limitation, the present invention performs dynamic load management of random access channels for a satellite FDMA/TDMA network with a switching satellite and ground-based user terminals. However, the present invention is not limited thereto, and the method can be used in other networks including, but not limited to, wireless and cable systems. Further, variations of the method can be used for other satellite and terrestrial systems.

The algorithms described in this invention can also be used in centralized approaches, where the channel load estimation computation is performed at a central NCC and then distributed to the terminals. The control message in that case is sent to the NCC.

The method of the present invention can also be used without the control message. For example, but not by way of limitation, the control information in the control message can be “piggy-backed” on the data message itself, thus eliminating the need for the control message. The data message is then monitored by all or one terminal, which then extracts the control information to perform the requisite computations.

Also, the present invention can be applied to slotted-aloha or unslotted-aloha channels. Additionally, in a system with a large number of random access slots that are spread, possibly across multiple carriers, a terminal may select a random subset of slots for its own usage.

Further, the retransmission protocol of the present invention can be implemented in the media access control (MAC) layer, so that upper layer protocols that generate data messages are not aware of or involved in random access channel management.

The present invention has various advantages over the related art. For example, but not by way of limitation, the present invention can be implemented efficiently in software or hardware. Also, the present invention does not require collision detection hardware. Further, the bandwidth overhead of the scheme is very small.

Additionally, it is an advantage of the present invention that floating point arithmetic is not required for the computations. For example, but not by way of limitation, fixed-point (i.e., scaled) arithmetic may be used, as 1n(x) can be computed using a table lookup for discrete values of x in the range of about 0 to 3 in steps of about 0.05.

In the first exemplary process of the present invention, the algorithm has an advantage in that it is fair to all terminals. Each terminal converges at the same value of the blocking probability b. Further, the second exemplary process of the present invention has the advantage of being computationally more efficient Accordingly, the algorithm is fair to all terminals over a long period of time, and only unfair for substantially short periods of time.

It will be apparent to those skilled in the art that various modifications and variations can be made to the described illustrative embodiments of the present invention without departing from the spirit or scope of the invention. Thus, it is intended that the present invention cover all modifications and variations of this invention consistent with the scope of the appended claims and their equivalents.

1. A method of sharing bandwidth among a plurality of terminals communicating with a satellite, comprising:
(a) designating a random access channel that is available for use by any of said plurality of terminals;
(b) estimating a load at said random access channel, wherein each of said terminals receives a control signal indicative of a traffic level of said random access channel, from said satellite and monitors said control signal to determine whether a data message transmitted from said terminals has been received in said satellite;
(c) retransmitting said data message from one of said terminals to said satellite if said terminal has not received said control signal within a first predetermined time period; and
(d) discarding said data message in said terminal if said terminal has received said control message.

2. The method of claim 1, wherein said control signal includes a blocking factor for said random access channel, said blocking factor being used by said terminals to block a prescribed percentage of traffic from entering said random access channel in accordance with a process performed in at least one of said terminals, and at least one retransmission value.

3. The method of claim 2, wherein one of (a) an exponential backoff strategy is applied to improve said blocking factor on each retransmission; and (b) said terminal selects said random access channel from a series of subsequent frames determined based on a number of usable random access channels in each of said subsequent frames.

4. The method of claim 2, further comprising:
each of said terminals receiving and monitoring all of said control signals, each of said control signals comprising information that enables each of said terminals to independently compute a channel loading; and
blocking a predetermined amount of traffic from said random access channel to maintain a loading of said random access channel below a prescribed threshold in accordance with said blocking factor, wherein said blocking factor is periodically recalculated.

5. The method of claim 4, further comprising:
initializing a value of the blocking factor to zero and an average of said at least one retransmission value to zero; and
updating said blocking factor at a second predetermined time period.

6. The method of claim 5, said updating comprising:
(a) computing said average of said at least one retransmission number value received over a half of said second predetermined time period, and if said control signal is not received within said half of said second predetermined time period, said average of said at least one retransmission value is set to a previous value of said at least one retransmission value multiplied by 0.95; and
(b) computing an average of said blocking factor based on values of said blocking factor received over said half of said second predetermined time period, and if said control signal is not received within said half of said second predetermined time period, said average of said blocking factor is set at a previous value of said blocking factor.

7. The method of claim 6, further comprising:
updating said blocking factor based on a subtraction factor modified in accordance with a channel load and a channel input load.

8. The method of claim 7, wherein said channel load is calculated based on 1n (said at least one retransmission value+1) and said channel input load is calculated by dividing said channel load by (said at least one retransmission value+1), and said subtraction factor is calculated by (1−(said blocking factor+said average of said blocking factor divided by two)).

9. The method of claim 8, further comprising modifying said subtraction factor by one of:
(a) dividing said subtraction factor by 2 if said channel load is greater than 1;
(b) multiplying said subtraction factor by a maximum input load divided by said channel input load if said channel input load is greater than said maximum input load; and
(c) adding said subtraction factor to a minimum of (i) 1 and (ii) said maximum input load divided by said channel input load, and divided by 2, and wherein said modified subtraction factor is set to a value greater than zero.

10. The method of claim 9, further comprising updating said modified blocking factor by subtracting said subtraction factor from 1.

11. The method of claim 2, wherein each of said terminals receives and monitors only a corresponding one of said control signals, and said blocking factor is iteratively adjusted.

12. The method of claim 11, further comprising initializing said blocking factor to zero, and when said control message is received, adjusting said blocking factor by one of:
(a) if said at least one retransmission value is greater than or equal to a prescribed threshold value indicative of a channel load that is too high, subtracting from a value of 1 a maximum of (i) said blocking factor subtracted from 1 and multiplied by a channel load decreasing factor and (ii) a minimum allowable value for said blocking value subtracted from 1; and
(b) if said at least one retransmission value is less than a value of 1 subtracted from a prescribed threshold value, indicative of said channel load being too low, subtracting from a value of 1 a minimum of (i) said blocking factor subtracted from 1 and multiplied by a channel load increasing factor and (ii) a value of 1.

13. The method of claim 11, wherein if said random access channel transmission is not successful, said terminal calculates said blocking factor by subtracting from a value of 1 a maximum of (i) said blocking factor subtracted from 1 and multiplied by a channel load decreasing factor, and (ii) a minimum allowable value for said blocking value subtracted from 1.

14. The method of claim 2, wherein said blocking factor is periodically collected by a network control center (NCC) to perform long-term monitoring of said random access channel and determine whether additional channel capacity is required.

15. The method of claim 2, wherein a network control center (NCC) can perform said random channel load estimation.

16. The method of claim 1, wherein said control signal is one of (i) a control message, and (ii) control information that is piggybacked onto said data message, from which said control information is extracted by said terminals.

17. The method of claim 1, wherein said method is applied to slotted-aloha or unslotted-aloha channels.

18. The method of claim 1, wherein said method is performed in a media access control (MAC) communication layer.

19. A system for sharing bandwidth during communication, comprising:
a plurality of terminals configured to wirelessly communicate with one another;
a random access channel configured to communicate data messages between any of said plurality of terminals in accordance with an estimated load of said random access channel, wherein each of said terminals receives a control signal indicative of a traffic level of said random access channel from a satellite, and monitors said control signal to determine whether a data message transmitted from said terminals has been received in said satellite.

20. The system of claim 19, wherein said data message is retransmitted from one of said terminals to said satellite if said terminal has not received said control signal within a first predetermined time period, and said data message is discarded in said terminal if said terminal has received said control message.

21. The system of claim 20, wherein said control signal includes a blocking factor for said random access channel, said blocking factor being used by said terminals to block a prescribed percentage of traffic from entering said random access channel in accordance with a process performed in at least one of said terminals, and at least one retransmission value.

22. The system of claim 20, wherein each of said terminals receives and monitors all of said control signals, each of said control signals comprising information that enables each of said terminals to independently compute a channel loading, and a predetermined amount of traffic is blocked from said random access channel to maintain a loading of said random access channel below a prescribed threshold in accordance with said blocking factor that is periodically recalculated.

23. The system of claim 22, further comprising a second predetermined time period during which said blocking factor is updated, wherein a value of the blocking factor is initialized to zero and an average of said at least one retransmission value to zero.

24. The system of claim 23, wherein,
said blocking factor is updated by computing said average of said at least one retransmission number value received over a half of said second predetermined time period, and if said control signal is not received within said half of said second predetermined time period, said average of said at least one retransmission value is set to a previous value of said at least one retransmission value multiplied by 0.95, and
an average of said blocking factor is computed, based on values of said blocking factor received over said half of said second predetermined time period, and if said control signal is not received within said half of said second predetermined time period, said average of said blocking factor is set to equal a previous value of said blocking factor.

25. The system of claim 24, wherein said blocking factor is updated based on a subtraction factor modified in accordance with a channel load and a channel input load.

26. The system of claim 25, wherein said channel load is calculated based on 1n (said at least one retransmission value+1) and said channel input load is calculated by dividing said channel load by (said at least one retransmission value+1), and said subtraction factor is calculated by (1−(said blocking factor+said average of said blocking factor divided by two)).

27. The system of claim 26, further wherein said subtraction factor is modified by one of:
(a) dividing said subtraction factor by 2 if said channel load is greater than 1;
(b) multiplying said subtraction factor by a maximum input load divided by said channel input load if said channel input load is greater than said maximum input load; and
(c) adding said subtraction factor to a minimum of (i) 1 and (ii) said maximum input load divided by said channel input load, and divided by 2, and wherein said modified subtraction factor is set to a value greater than zero.

28. The system of claim 27, wherein said modified blocking factor is updated by subtracting said subtraction factor from 1.

29. The system of claim 20, wherein each of said terminals receives and monitors only a corresponding one of said control signals, and said blocking factor is configured to be iteratively adjusted.

30. The system of claim 29, wherein said blocking factor is initialized to zero, and when said control message is received, said blocking factor is adjusted by one of:
(a) if said at least one retransmission value is greater than or equal to a prescribed threshold value indicative of a channel load that is too high, subtracting from a value of 1 a maximum of (i) said blocking factor subtracted from 1 and multiplied by a channel load decreasing factor and (ii) a minimum allowable value for said blocking value subtracted from 1; and
(b) if said at least one retransmission value is less than a value of 1 subtracted from a prescribed threshold value, indicative of said channel load being too low, subtracting from a value of 1 a minimum of (i) said blocking factor subtracted from 1 and multiplied by a channel load increasing factor and (ii) a value of 1.

31. The system of claim 29, wherein if said random access channel transmission is not successful, said terminal calculates said blocking factor by subtracting from a value of 1 a maximum of (i) said blocking factor subtracted from 1 and multiplied by a channel load decreasing factor, and (ii) a minimum allowable value for said blocking value subtracted from 1.

32. The system of claim 19, wherein said control signal is one of (i) a control message, and (ii) control information that is piggybacked onto said data message, from which said control information is extracted by said terminals.

33. The system of claim 19, wherein said system is configured to operate in slotted-aloha or unslotted-aloha channels, and said method is performed in a media access control (MAC) communication layer.
